(19) United States
(12) Patent Application Publication
(10) Pub. No.: US 2007/0288236 A1
(43) Pub. Date: Dec. 13, 2007

(54) Speech signal pre-processing system and method of extracting characteristic information of speech signal

(75) Inventor: Hyun-Soo Kim, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/728,715

(22) Filed: Mar. 27, 2007

(30) Foreign Application Priority Data
Apr. 5, 2006 (KR) 10-2006-0031144

(51) Int. Cl. G10L 15/00

(52) U.S. Cl. 704/231; 704/E15.001

(57) ABSTRACT

A speech signal pre-processing system and a method of extracting characteristic information of a speech signal. To do this, it is determined whether characteristic information of an input speech signal is extracted using harmonic peaks. According to the determination result, a speech signal frame or characteristic frequency regions derived according to a morphological analysis result is (are) input to a speech signal characteristic information extractor for extracting speech signal characteristic information requested by a speech signal processing system in a next stage. The speech signal characteristic information extractor selected by a controller receives the speech signal frame or the characteristic frequency regions derived according to a morphological analysis result and extracts the speech signal characteristic information requested by the speech signal processing system.

### PRIORITY

This application claims priority under 35 U.S.C. §119 to an application filed in the Korean Intellectual Property Office on Apr. 5, 2006 and assigned Serial No. 2006-31144, the contents of which are incorporated herein by reference.

### BACKGROUND OF THE INVENTION

1. Field of the Invention

The present invention generally relates to a speech signal recognition system, and in particular, to a speech signal pre-processing system which extracts characteristic information of a speech signal.

2. Description of the Related Art

In general, a speech signal pre-processing process is a very important process to cancel noise of a speech signal and extract characteristic information of the speech signal, such as an envelope, pitches, voiced/unvoiced sound, etc., according to a spectrum of the speech signal, which is used for a speech signal processing system (including all speech-related systems, such as a coder/decoder (codec), synthesis, recognition, etc.) in a next stage.

A system for extracting characteristic information of a speech signal specified according to needs of a speech signal processing system in a next stage has normally been applied to speech signal pre-processing systems performing a speech signal pre-processing process. An example of a speech signal pre-processing system is a pre-processing system for extracting characteristic information of a speech signal, which is based on Linear Prediction (LP) usually used in a Code Excited Linear Prediction (CELP) series codec.

Such a conventional speech signal pre-processing system uses an LP analysis method to detect a speech signal and extract characteristic information of the detected speech signal. Using the LP analysis method, a computation amount can be reduced by expressing characteristic information of a speech signal using only parameters. The LP analysis method estimates a current value from a past sample value by assuming current samples from a linear set using past speech signal samples. This conventional LP analysis method has advantages that a waveform and spectrum of a speech signal can be expressed using a few parameters and the parameters can be extracted through simple calculation.

However, since a speech signal pre-processing system using the conventional LP analysis method includes individual systems for providing characteristics, such as pitches, spectrum, voiced/unvoiced sound, etc., of a speech signal, if a speech signal processing system in a next stage is changed, the speech signal pre-processing system should be changed as well.

### SUMMARY OF THE INVENTION

An object of the present invention is to substantially solve at least the above problems and/or disadvantages and to provide at least the advantages below. Accordingly, an object of the present invention is to provide a speech signal pre-processing system and a method of extracting characteristic information of a speech signal, whereby characteristics of the speech signal requested by various speech signal processing systems can be selectively provided by synthetically extracting characteristic information of the speech signal.

According to one aspect of the present invention, there is provided a speech signal pre-processing system including a speech signal recognition unit for recognizing speech from an input signal and outputting the input signal as a speech signal; a speech signal converter for generating a speech signal frame by receiving the speech signal and converting the received speech signal of a time domain to a speech signal of a frequency domain; a morphological analyzer for receiving the speech signal frame and generating characteristic frequency regions having a morphological analysis-based signal waveform through a morphological operation; a speech signal characteristic information extractor for receiving the speech signal frame or the morphological analysis-based characteristic frequency regions and extracting speech signal characteristic information requested by a speech signal processing system in a next stage; and a controller for determining according to a pre-set determination condition whether the characteristic information of the speech signal is extracted using harmonic peaks of the speech signal frame, and extracting the speech signal characteristic information requested by the speech signal processing system by outputting the speech signal frame to the speech signal characteristic information extractor when harmonic peaks are used or outputting the morphological analysis-based characteristic frequency regions of the speech signal frame when harmonic peaks are not used.

According to another aspect of the present invention, there is provided a method of extracting characteristic information of a speech signal, the method including generating a speech signal frame by recognizing speech from an input signal, extracting the speech, and converting the received input signal of a time domain to a speech signal of a frequency domain, and outputting the speech signal; determining according to a pre-set determination condition whether characteristic information of the speech signal is extracted using harmonic peaks of the speech signal frame; performing a morphological analysis of the speech signal frame according to a harmonic peaks usage determination result and extracting characteristic frequency regions according to a morphological analysis result; extracting the speech signal characteristic information requested by a speech signal processing system in a next stage using the characteristic frequency regions of the speech signal frame according to the harmonic peaks usage determination result; and outputting the extracted speech signal characteristic information to the speech signal processing system.

### BRIEF DESCRIPTION OF THE DRAWINGS

The above and other objects, features and advantages of the present invention will become more apparent from the following detailed description when taken in conjunction with the accompanying drawing in which:

FIG. 1 is a block diagram of a speech signal pre-processing system according to the present invention;

FIG. 2 are waveform diagrams (a) and (b) of a speech signal output according to a morphological analysis result from a speech signal pre-processing system according to the present invention;

FIG. 3 is a flowchart illustrating a process of outputting characteristic information of a speech signal using harmonic peaks or a morphological analysis scheme in a speech signal pre-processing system according to the present invention;

FIG. 4 is a flowchart illustrating a process of outputting speech signal characteristic information according to information requested by a speech signal processing system in a speech signal pre-processing system according to the present invention;

FIG. 5 is a flowchart illustrating a process of extracting envelope information of a speech signal using harmonic peaks in a speech signal pre-processing system according to the present invention;

FIGS. 6A to 6C are reference diagrams for explaining how to obtain secondary harmonic peaks according to the present invention;

FIG. 7 is a flowchart illustrating a process of determining using harmonic peaks whether a speech signal is a voiced or unvoiced sound in a speech signal pre-processing system according to the present invention;

FIG. 8 is a flowchart illustrating a case where a second neural network is used in the process illustrated in FIG. 7, according to the present invention;

FIG. 9 is a flowchart illustrating a morphological analysis process of a speech signal pre-processing system, wherein an input speech signal is analyzed using a morphological operation, according to the present invention;

FIG. 10 is a flowchart illustrating a process of determining an optimal structuring set size (SSS) for a morphological analysis in the process illustrated in FIG. 9, according to the present invention;

FIG. 11 is a flowchart illustrating a process of extracting characteristic information of a speech signal using a signal waveform output according to a morphological analysis result in a speech signal pre-processing system according to the present invention;

FIG. 12 is a flowchart illustrating a process of extracting envelope information of a speech signal using a signal waveform output according to a morphological analysis result in a speech signal pre-processing system according to the present invention;

FIG. 13 is a flowchart illustrating a process of determining using a signal waveform output according to a morphological analysis result whether a speech signal is a voiced or unvoiced sound in a speech signal pre-processing system according to the present invention; and

FIG. 14 is a flowchart illustrating a case where a second neural system is used in the process illustrated in FIG. 13, according to the present invention.

### DETAILED DESCRIPTION OF THE PREFERRED EMBODIMENTS

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

The cardinal principles will now be first described to fully understand the present invention. In a speech signal pre-processing system according to the present invention, it is determined whether characteristic information of an input speech signal is extracted using harmonic peaks. This determination may depend on the input speech signal or a characteristic of a speech signal processing system in a next stage.

If harmonic peaks are used, a controller of the speech signal pre-processing system outputs a speech signal frame, which is generated by converting the input speech signal to a speech signal of a frequency domain, to a speech signal characteristic information extractor. Here, the controller can select at least one of a plurality of speech signal characteristic information extractors according to speech signal characteristic information requested by the speech signal processing system in a next stage. The speech signal characteristic information extractor selected by the controller extracts the speech signal characteristic information requested by the speech signal processing system in a next stage. The controller outputs the extracted speech signal characteristic information. The characteristic information of a speech signal may be envelope information of the speech signal, pitch information of the speech signal, or a determination result of whether the speech signal is a voiced sound, an unvoiced sound, or background noise.

If harmonic peaks are not used, the controller performs a morphological analysis of the generated speech signal frame using a morphological analysis scheme. The controller extracts a signal waveform according to the morphological analysis result and outputs the extracted signal waveform instead of the speech signal frame to each of the plurality of speech signal characteristic information extractors. Each of the plurality of speech signal characteristic information extractors receives the signal waveform according to the morphological analysis result instead of the speech signal frame and extracts characteristic information of the input speech signal using the received signal waveform. The controller outputs the extracted speech signal characteristic information to the speech signal processing system in a next stage.

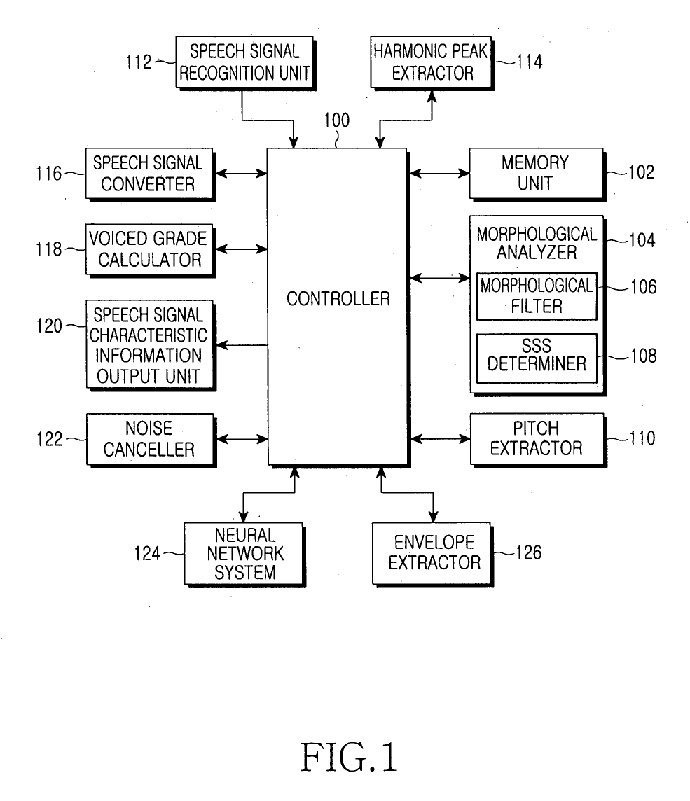

FIG. 1 shows a speech signal pre-processing system according to the present invention. The speech signal pre-processing system includes a controller 100, and a memory unit 102, a morphological analyzer 104, a pitch extractor 110, an envelope extractor 126, a neural network system 124, a noise canceller 122, a speech signal characteristic information output unit 120, a voiced grade calculator 118, and a speech signal converter 116, which are connected to the controller 100. The controller 100 controls the components to receive a speech signal and extract speech signal characteristic information requested by a speech signal processing system in a next stage from the received speech signal.

The controller 100 receives a speech signal and converts the speech signal to a speech signal of a frequency domain. The controller 100 determines, according to the received speech signal or a characteristic of a speech signal processing system in a next stage, whether characteristic information of the speech signal is extracted using harmonic peaks of a speech signal frame. According to the determination result, the controller 100 extracts the characteristic information of the speech signal using harmonic peaks found using a harmonic peak extractor 114 or using a signal waveform generated through a morphological analysis result of the speech signal.

Morphology is usually used for image signal processing, and morphology in a mathematical concept is a nonlinear image processing and analyzing method concentrating on a geometric structure of an image, in which erosion and dilation corresponding to a primary operation, and opening and closing corresponding to a secondary operation are important. A plurality of linear or nonlinear operators can be formed using a set of simple morphologies.

A basic operation of a morphological analysis is erosion, wherein in erosion of a set A by a set B, A denotes an input image, and B denotes a structuring element. If an origin is in the structuring element, erosion tends to shrink the input image. Dilation, another basic operation, is a dual operation of erosion and is defined as a set complementation of erosion. Opening is another basic operation, and is iteration of erosion and dilation. Closing is another basic operation, and is a dual operation of opening.

A dilation operation determines maxima of each predetermined threshold set of a speech signal image as values of the threshold set. An erosion operation determines minima of each predetermined threshold set of a speech signal image as values of the threshold set. An opening operation is an operation performing the dilation operation after the erosion operation and shows a smoothing effect. A closing operation is an operation performing the erosion operation after the dilation operation and shows a filling effect.

While a morphological operation applied to the present invention is normally not used in speech signal processing, when a morphological operation is used when a characteristic frequency is extracted, a harmonic signal and a non-harmonic signal can be correctly divided and extracted. Thus, by applying a morphological scheme to the present invention, valid characteristic frequency regions can be extracted from a speech signal in which a voiced sound and an unvoiced sound are mixed, and can be applied to a harmonic coder/decoder (codec). That is, when a morphological scheme is applied, a non-harmonic signal can also be applied to the harmonic codec.

Thus, when a determination result indicates harmonic peaks of a speech signal are not used, the controller 100 generates a meaningful characteristic frequency of a currently input speech signal through a morphological analysis, i.e., a signal waveform according to the morphological analysis, and extracts characteristic information of the input speech signal by outputting a generated signal waveform to a speech signal characteristic information extractor similar to usage of a harmonic codec.

The memory unit 102 connected to the controller 100 includes a Read Only Memory (ROM), a flash memory, and a Random Access Memory (RAM). The ROM stores programs and various kinds of reference data for processing and controlling of the controller 100, the RAM provides a working memory of the controller 100, and the flash memory provides an area for storing various kinds of updatable storage data.

A speech signal recognition unit 112 recognizes a speech signal from an input signal and outputs the input signal to the controller 100 as the speech signal. The speech signal converter 116 generates a speech signal frame by receiving the speech signal and converting the received speech signal to a speech signal of a frequency domain under control of the controller 100. The noise canceller 122 cancels noise from the speech signal frame. The harmonic peak extractor 114 searches for and extracts harmonic peaks from the speech signal frame under a control of the controller 100. The speech signal characteristic information output unit 120 outputs characteristic information of the input speech signal to the speech signal processing system in a next stage under control of the controller 100.

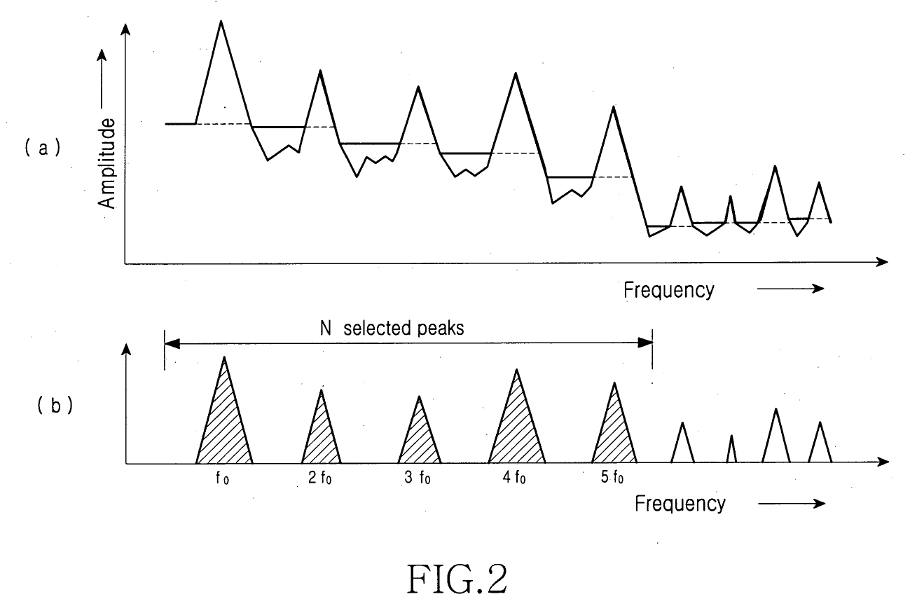

The morphological analyzer 104 includes a morphological filter 106 and a structuring set size (SSS) determiner 108 and generates a signal waveform according to a morphological analysis through a morphological operation of an input speech signal frame. The morphological filter 106 selects harmonic peaks through the morphological closing. After performing the morphological closing, a waveform shown in FIG. 2A is obtained. If the waveform diagram (a) shown in FIG. 2 is pre-processed, a remainder (or residual) spectral waveform diagram (b) is obtained. The remainder spectrum indicates signals existing above a closure floor represented by a dotted line shown in waveform diagram (a), and after the pre-processing, only characteristic frequency regions remain as shown in waveform diagram (b). That is, after the pre-processing, signals obtained by removing staircase signals from signals output after performing the morphological closing are the signals shown in waveform diagram (b). Through the pre-processing, harmonic content is emphasized in a voiced sound, and a major sinusoidal component is emphasized in an unvoiced sound.

In order to optimize the performance of the morphological filter 106, an optimal window size for performing a morphological operation is determined. To determine the optimal window size, the. SSS determiner 108 is included in the morphological analyzer 104. The SSS determiner 108 determines an SSS for optimizing performance of the morphological filter 106 and provides the determined SSS to the morphological filter 106. A process of determining an SSS can be selectively used as desired, i.e., determined as default or by a method described below.

A process of determining an SSS will now be described. A number of signals having the biggest harmonic peak, i.e., the number of the biggest harmonic peaks, is assumed to be N. When N selected peaks corresponding to shaded areas of waveform diagram (b) in FIG. 2 are defined, a value P is calculated using the N selected peaks. P denotes a ratio of energy of the N selected peaks to energy of the other remainder spectrum. For example, in waveform diagram (b), if N=5, a value obtained by summing the shaded areas is the energy E_{N} of the N selected peaks, and the energy of the other remainder spectrum is Eₜₒₜₐₗ, P=E_{N}/Eₜₒₜₐₗ. The value P is compared to an SSS with no assumption regarding the signals, and if the value P is too large (e.g., SSS<0.5), N is decreased, and if the value P is too small (e.g., SSS>0.5), N is increased. Thus, since a speech signal has high pitches in a case of female speakers, the number of total harmonic peaks is small, and thus, a smaller N value is selected for female speakers as compared to male speakers. Through the above-described process, an optimal SSS of the morphological filter 106, which performs the morphological closing of a waveform converted to a speech signal in the frequency domain, is determined. If the method of selecting an SSS by adjusting N is not used, an optimal SSS may be selected by beginning from the smallest SSS and increasing it step by step.

Since a morphological operation is a set-theoretical approach method depending on fitting a structuring element to a certain specific value, a one-dimensional image structuring element, such as a speech signal waveform, is represented as a set of discrete values. A structuring set is determined by a sliding window symmetrical to the origin, and the size of the sliding window determines performance of the morphological operation.

According to the present invention, the window size is obtained by Equation (1).
window size=(structuring set size (SSS)×2+1) (1)

As shown in Equation (1), the window size depends on an SSS. Thus, the performance of a morphological operation can be adjusted by adjusting the size of a structuring set. Thus, the morphological filter 106 can perform a morphological operation, such as dilation, erosion, opening, or closing, using a sliding window according to an SSS determined by the SSS determiner 108.

Thus, the morphological filter 106 performs a morphological operation with respect to the speech signal waveform in the frequency domain using the SSS determined by the SSS determiner 108. That is, the morphological filter 106 performs the morphological closing with respect to the converted speech signal waveform and performs pre-processing.

A signal transforming method of the morphological filter 106 is a nonlinear method in which geometric features of an input signal are partially transformed and has an effect of contraction, expansion, smoothing, and/or filling according to the four operations, i.e., erosion, dilation, opening, and closing. An advantage of this morphological filtering is that peak or valley information of a spectrum can be correctly extracted with a very small amount of computation. Furthermore, the morphological filtering is nonparametric. For example, unlike a conventional harmonic codec assuming a harmonic structure of a speech signal, no assumption exists for an input signal in the present invention.

The morphological closing provides an effect of filling valleys between harmonic peaks in a speech signal spectrum, and thus, as shown in waveform diagram (b) of FIG. 2, the harmonic peaks remain while small spurious peaks exist below a morphological closing spectrum.

Thus, the controller 100 can select only characteristic frequency regions included in the speech signal from a result of the morphological operation performed by the morphological filter 106. Only the characteristic frequency regions can be selected by suppressing noise. All characteristic frequency regions for representing the speech signal are extracted by selecting all harmonic peaks including small harmonic peaks as shown in waveform diagram (b) of FIG. 2. If the extracted characteristic frequency regions have the attribute of a voiced sound, harmonic peaks having constant periodicity, such as f₀, 2 f₀, 3 f₀, 4 f₀, 5 f₀, . . . , appear. That is, by applying the morphological scheme to the speech signal without distinguishing a voiced sound from an unvoiced sound, a characteristic frequency to be applied instead of a pitch frequency to a harmonic codec performing harmonic coding is extracted.

In particular, remainder peaks remaining by performing the pre-processing in waveform diagram (b) of FIG. 2 appear due to a major sine wave component corresponding to the characteristic frequency of the speech signal. Unlike a general harmonic extraction method, the characteristic frequency is a frequency region of all sine waves representing a speech signal.

The speech signal pre-processing system includes the pitch extractor 110, the envelope extractor 126, and the neural network system 124 as speech signal characteristic information extractors for extracting characteristic information of an input speech signal. The pitch extractor 110 extracts pitch information using a specific speech signal frame of which harmonic peaks are extracted or a signal waveform according to a morphological analysis result, which is input from the controller 100. The envelope extractor 126 extracts envelope information of the harmonic peaks and envelope information of non-harmonic peaks from the specific speech signal frame of which harmonic peaks are extracted or the signal waveform according to the morphological analysis result under a control of the controller 100, and outputs the envelope information of the harmonic peaks and the envelope information of the non-harmonic peaks to the controller 100. If the speech signal processing system in a next stage requests for the envelope information of the harmonic peaks and the envelope information of the non-harmonic peaks, the controller 100 outputs the envelope information of the harmonic peaks and the envelope information of the non-harmonic peaks to the speech signal processing system in a next stage. However, the envelope information may be used to identify whether the speech signal frame corresponds to a voiced sound, an unvoiced sound, or background noise. In this case, the controller 100 determines using an energy ratio of the envelope information of the harmonic peaks to the envelope information of the non-harmonic peaks whether the speech signal frame corresponds to a voiced sound, an unvoiced sound, or background noise. To do this, the controller 100 includes the voiced grade calculator 118 for calculating an energy ratio of the harmonic peak envelope information to the non-harmonic peak envelope information, and determining according to a result of the calculated voiced grade whether the speech signal frame corresponds to a voiced sound, an unvoiced sound, or background noise.

The neural network system 124 detects characteristic information from the speech signal frame or characteristic frequency regions according to the morphological analysis result, grants a pre-set weight to each piece of the detected characteristic information, and determines according to a neural network recognition result whether the speech signal frame corresponds to a voiced sound, an unvoiced sound, or background noise. The neural network system 124 may include at least two neural networks to increase a recognition accuracy of the speech signal frame.

When a determination result of the speech signal frame or a speech signal corresponding to the characteristic frequency regions according to first neural network recognition does not indicate a voiced sound, the neural network system 124 reserves the determination of the speech signal frame or the characteristic frequency regions, performs second neural network recognition using a voiced sound/unvoiced sound/background noise determination result of the first neural network with respect to at least one different speech signal frame or characteristic frequency regions, and secondary statistical values of various kinds of characteristic information extracted from the different speech signal frames or characteristic frequency regions, and determines according to a result of the second neural network recognition whether the speech signal frame corresponds to a voiced sound, an unvoiced sound, or background noise. The secondary statistical values are statistical values calculated for each piece of characteristic information extracted from the different speech signal frames or characteristic frequency regions.

FIG. 1 shows a speech signal pre-processing system according to the present invention. Thus, this configuration including the speech signal characteristic information extractors can be modified or added more according to speech signal characteristic information requested by the speech signal processing system in a stage next to the speech signal pre-processing system according to the present invention.

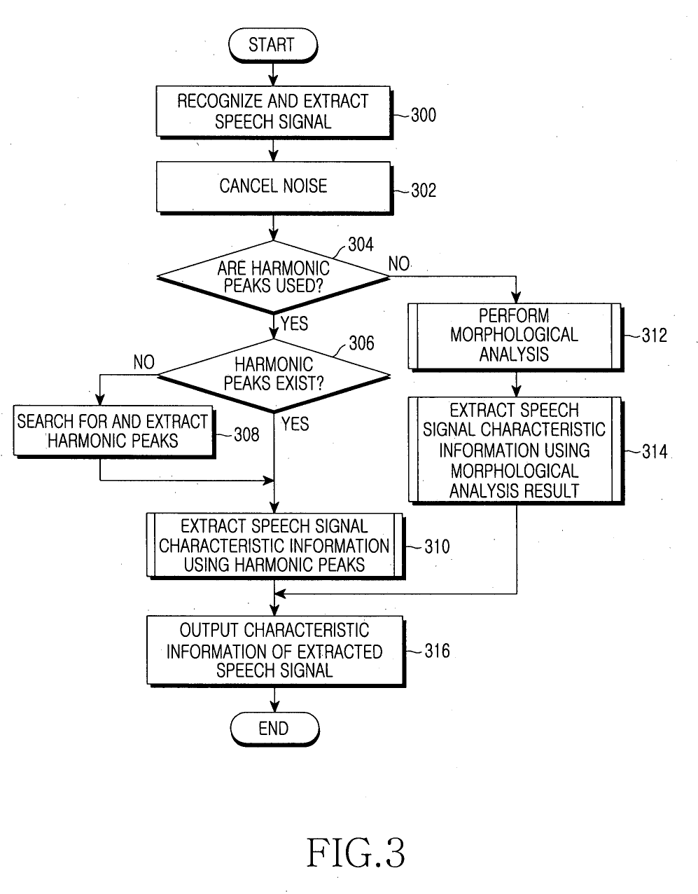

FIG. 3 shows a process of outputting characteristic information of a speech signal using harmonic peaks or a morphological analysis scheme in the speech signal pre-processing system of FIG. 1, according to the present invention. When a signal is input, the controller 100 recognizes a speech signal from the input signal through the speech signal recognition unit 112, extracts the speech signal, and converts the extracted speech signal to a speech signal of a frequency domain through the speech signal converter 116 in step 300. The controller 100 cancels noise from the converted speech signal through the noise canceller 122 in step 302. Various methods of canceling noise can be used in the controller 100. For example, the controller 100 can set a different weight according to the amplitude of each extracted speech signal frame and perform a square operation of the amplitude according to the set weight. By setting a predetermined threshold and granting a (+) or (−) sign to a result of the square operation according to whether the result of the square operation is greater than the threshold, the controller 100 can set a greater amplitude ratio of a signal having an amplitude less than the threshold, i.e., a signal estimated as noise, to a signal having an amplitude greater than or equal to the threshold.

After completing the noise cancellation process of step 302, the controller 100 determines in step 304 whether speech signal characteristic information is extracted using harmonic peaks of the speech signal frame. The determination can be performed according to the input speech signal or a characteristic of a speech signal processing system in a next stage. For example, according to whether the signal input to the speech signal recognition unit 112 has enough harmonic peaks to extract characteristic information of a speech signal, the controller 100 can determine whether harmonic peaks are used to extract the characteristic information of the speech signal. If the signal input to the speech signal recognition unit 112 does not have enough harmonic peaks to extract the characteristic information of the speech signal, the controller 100 can determine according to a request of the speech signal processing system in a next stage whether the harmonic peaks are used.

If it is determined in step 304 that harmonic peaks are used, the controller 100 determines in step 306 whether harmonic peaks of a currently input speech signal frame exist. When the determination result of step 306 indicates uncertainty regarding existence of harmonic peaks for the currently input speech signal frame, the controller 100 extracts harmonic peaks of the currently input speech signal frame through the harmonic peak extractor 114 in step 308. The controller 100 can use any desired method for extracting the harmonic peaks.

When step 306 determines that harmonic peaks of the currently input speech signal frame exist, the controller 100 selects a speech signal characteristic information extractor for extracting speech signal characteristic information requested by the speech signal processing system in a next stage, and extracts characteristic information of the input speech signal from the harmonic peaks of the speech signal frame by outputting the speech signal frame to the selected speech signal characteristic information extractor in step 310. The controller 100 outputs the extracted speech signal characteristic information to the speech signal processing system in a next stage in step 316.

When step 304 determines that harmonic peaks are not used, the controller 100 outputs the speech signal frame to the morphology analyzer 104, controls the morphology analyzer 104 to perform a morphology operation, and extracts a signal waveform according to the morphological analysis result from the speech signal frame in step 312.

The controller 100 selects a speech signal characteristic information extractor for extracting speech signal characteristic information requested by the speech signal processing system in a next stage, and extracts characteristic information of the input speech signal from the harmonic peaks extracted from the signal waveform according to the morphological analysis result by outputting the extracted signal waveform to the selected speech signal characteristic information extractor in step 314. The controller 100 outputs the extracted speech signal characteristic information to the speech signal processing system in a next stage in step 316.

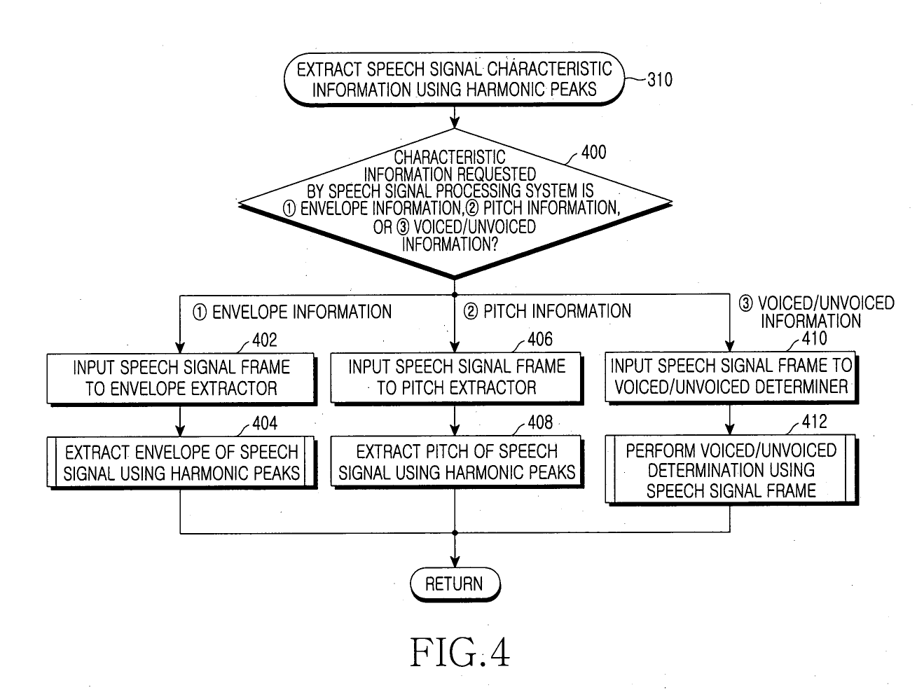

FIG. 4 shows a process of outputting the characteristic information of a speech signal according to information requested by a speech signal processing system in a stage next to the speech signal pre-processing system shown in FIG. 1, according to the present invention. In FIG. 4, it is assumed that the speech signal processing system requests one of envelope information, pitch information, and voiced sound/unvoiced sound/background noise determination result information of the input speech signal.

Referring to FIG. 4, when a speech signal frame including harmonic peaks is input through step 306 or 308 of FIG. 3, the controller 100 extracts characteristic information of the input speech signal from the harmonic peaks of the speech signal frame by outputting the speech signal frame to the selected speech signal characteristic information extractor in step 310, and determines in step 400 whether speech signal characteristic information requested by the speech signal processing system according to the present invention is envelope information, pitch information, or voiced sound/unvoiced sound/background noise determination result information. According to the determination result of step 400, the input speech signal is input to a corresponding speech signal characteristic extractor.

When step 400 determines that the speech signal characteristic information requested by the speech signal processing system is envelope information, the controller 100 outputs the speech signal frame to the envelope extractor 126 in step 402. The controller 100 extracts envelope information of the speech signal frame using harmonic peaks of the speech signal frame in step 404. The envelope extractor 126 selects harmonic peaks by detecting a maximum peak as a first harmonic peak from the speech signal frame for a first pitch period and detecting maximum harmonic peaks of subsequent search zones, and extracts the envelope information from the selected harmonic peaks using interpolation.

After extracting the envelope information, the controller 100 outputs the extracted envelope information to the speech signal processing system in a next stage in step 316 of FIG. 3. If the speech signal processing system in a next stage requests not only the envelope information of the harmonic peaks but also envelope information of other remaining peaks, i.e., non-harmonic envelope information, the non-harmonic envelope information can be extracted from the speech signal frame. The envelope extractor 126 may extract envelope information of secondary harmonic peaks using the harmonic peaks. The secondary harmonic peaks indicate harmonic peaks extracted from the extracted envelope. The envelope information of the secondary harmonic peaks may be used to increase an accuracy of a process of determining whether the speech signal is a voiced sound or an unvoiced sound. For example, a method of using an energy ratio of the harmonic peak envelope information to the non-harmonic peak envelope information can be used as one method of determining, based on envelope information, whether the speech signal is a voiced sound or an unvoiced sound.

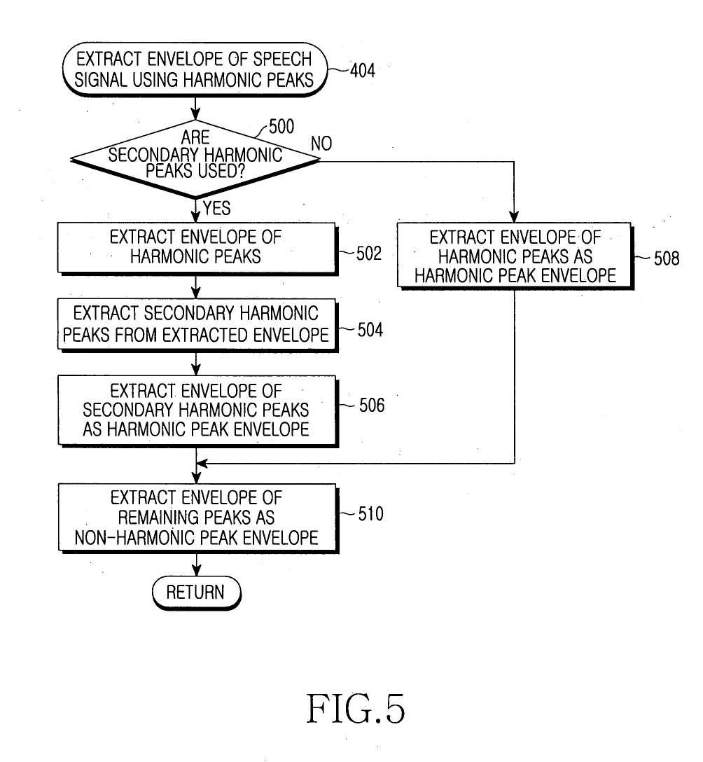

However, when envelope information of the secondary harmonic peaks is used, an energy ratio of the non-harmonic peak envelope information to the secondary harmonic peak envelope information is greater. Thus, in general, if the envelope information of the secondary harmonic peaks is used when the speech signal is a voiced sound in which harmonic peaks exist periodically, the energy ratio is much greater than when the speech signal is an unvoiced sound in which harmonic peaks exist non-periodically. When envelope information of the secondary harmonic peaks, i.e., the secondary harmonic peak envelope information, is used, the controller 100 can determine more correctly whether the input speech signal is a voiced sound or an unvoiced sound. An operation of the envelope extractor 126 according to the present invention, which includes the process of extracting envelope information of secondary harmonic peaks, will be described later with reference to FIG. 5.

When step 400 determines that the speech signal characteristic information requested by the speech signal processing system is pitch information, the controller 100 outputs the speech signal frame to the pitch extractor 110 in step 406. The controller 100 extracts pitch information of the speech signal using harmonic peaks of the speech signal frame in step 408. The controller 100 can use various methods to extract the pitch information from the speech signal frame. For example, the controller 100 can use a method of extracting the pitch information by detecting an energy ratio of a harmonic area to a noise area from the speech signal frame and determining peaks having the maximum energy ratio as the pitch information. After extracting the pitch information, the controller 100 outputs the extracted pitch information to the speech signal processing system in a next stage in step 316 of FIG. 3.

When step 400 determines that the speech signal characteristic information requested by the speech signal processing system is a voiced sound/unvoiced sound/background noise determination result, the controller 100 outputs the speech signal frame to a speech signal characteristic information extractor for determination of a voiced/unvoiced sound in step 410. The controller 100 determines in step 412 whether the speech signal frame corresponds to a voiced sound or an unvoiced sound. The voiced sound/unvoiced sound determination can be performed by using a recognition result of the neural network system 124 (the former) or using secondary harmonic peak envelope information and non-harmonic peak envelope information extracted by the envelope extractor 126 (the latter).

In the former case, the controller 100 outputs the speech signal frame to the neural network system 124. According to a recognition result of the neural network system 124, the controller 100 determines whether the input speech signal is a voiced sound, an unvoiced sound, or background noise. In the latter case, the controller 100 outputs the speech signal frame to the envelope extractor 126. The controller 100 extracts secondary harmonic peak envelope information and non-harmonic peak envelope information through the envelope extractor 126 and outputs the extracted secondary harmonic peak envelope information and non-harmonic peak envelope information to the voiced grade calculator 118. The voiced grade calculator 118 calculates an energy ratio of the secondary harmonic peak envelope information to the non-harmonic peak envelope information and compares the calculated envelope information energy ratio to a pre-set voiced threshold. If the envelope information energy ratio is greater than or equal than the pre-set voiced threshold, the voiced grade calculator 118 determines that the input speech signal is a voiced sound, and if the envelope information energy ratio is less than the pre-set voiced threshold, the voiced grade calculator 118 determines that the input speech signal is an unvoiced sound or background noise.

When a voiced threshold and an unvoiced threshold are set, the voiced grade calculator 118 may determine that the input speech signal is a voiced sound if the envelope information energy ratio is greater than the voiced threshold, an unvoiced sound if the envelope information energy ratio is less than the voiced threshold and greater than or equal to the unvoiced threshold, or background noise if the envelope information energy ratio is less than the unvoiced threshold. This is because since no harmonic peaks exist in background noise but harmonic peaks with low periodicity exist in an unvoiced sound, the envelope information energy ratio for unvoiced sound is much greater than the envelope information energy ratio for background noise. After extracting the determination result of step 412, the controller 100 outputs the extracted determination result to the speech signal processing system in a next stage in step 316 of FIG. 3.

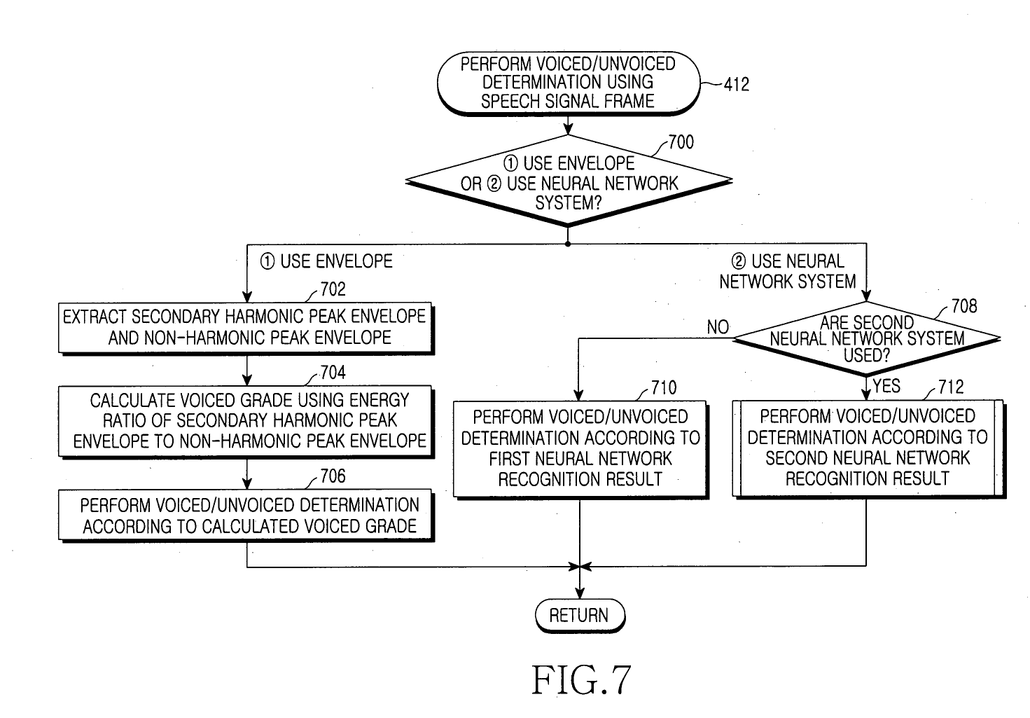

The process of the case where the speech signal characteristic information requested by the speech signal processing system in a next stage is voiced/unvoiced sound determination result information will be described in detail later with reference to FIG. 7.

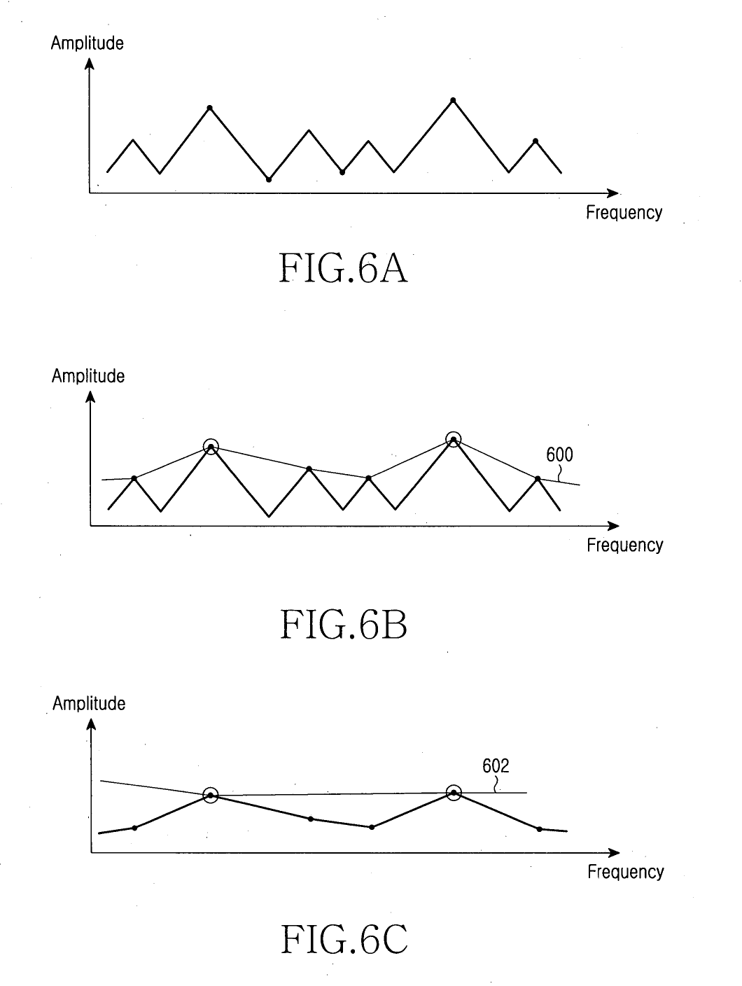

FIG. 5 shows a process of extracting envelope information of a speech signal using harmonic peaks in the speech signal pre-processing system shown in FIG. 1, according to the present invention. FIGS. 6A to 6C are reference diagrams for explaining how to obtain secondary harmonic peaks according to the present invention.

Referring to FIGS. 5 to 6C, when the speech signal frame is input to the envelope extractor 126 in step 402 of FIG. 4, the controller 100 determines in step 500 whether secondary harmonic peaks are necessary. If the speech signal processing system in a next stage requests secondary harmonic peaks, or if secondary harmonic peaks are used in the voiced sound/unvoiced sound determination of the input speech signal of step 412 of FIG. 4, the controller 100 determines in step 500 that secondary harmonic peaks are necessary.

However, when step 500 determines that secondary harmonic peaks are unnecessary, the controller 100 extracts envelope information by selecting harmonic peaks from the speech signal frame and applying interpolation to the selected harmonic peaks in step 508. The controller 100 extracts envelope information of the remaining peaks, which have not been selected as the harmonic peaks, as non-harmonic peak envelope information by applying interpolation to the remaining peaks in step 510. If the non-harmonic peak envelope information is unnecessary, i.e., if the speech signal processing system in a next stage requests only the harmonic peak envelope information, step 510 can be omitted.

When step 500 determines that secondary harmonic peaks are necessary, the controller 100 extracts envelope information of harmonic peaks from the speech signal frame in step 502. The controller 100 extracts secondary harmonic peaks from the extracted envelope information in step 504. For example, if the speech signal frame shown in FIG. 6A is input, the controller 100 selects harmonic peaks from the speech signal frame shown in FIG. 6A, extracts envelope information 600 shown in FIG. 6B by applying interpolation to the selected harmonic peaks, and selects secondary harmonic peaks from the extracted envelope information 600. The controller 100 extracts envelope information 602, which is shown in FIG. 6C, of the secondary harmonic peaks by applying interpolation to the selected secondary harmonic peaks in step 506. The controller 100 extracts envelope information of the remaining peaks, which have not been selected as the harmonic peaks when the envelope information of the primary harmonic peaks were extracted, as non-harmonic peak envelope information by applying interpolation to the remaining peaks in step 510. If the non-harmonic peak envelope information is unnecessary, i.e., if the voiced sound/unvoiced sound determination using the envelope information ratio is unnecessary or if the speech signal processing system in a next stage requests only the secondary harmonic peak envelope information, step 510 can be omitted.

FIG. 7 is shows a process of determining using harmonic peaks whether a speech signal is a voiced or unvoiced sound in the speech signal pre-processing system shown in FIG. 1, according to the present invention.

When step 400 of FIG. 4 determines that the speech signal characteristic information requested by the speech signal processing system is a voiced sound/unvoiced sound determination result, the controller 100 outputs the speech signal frame to a voiced/unvoiced determiner in step 410 of FIG. 4, and determines using harmonic peaks of the speech signal frame in step 412 of FIG. 4 whether the speech signal frame corresponds to a voiced sound or an unvoiced sound. The controller 100 can determine using various methods related to harmonic peaks whether the speech signal frame corresponds to a voiced sound or an unvoiced sound. However, it is assumed as described above that whether the speech signal frame corresponds to a voiced sound or an unvoiced sound is determined using a set of the envelope extractor 126 and the voiced grade calculator 118, or the neural network system 124.

Thus, the voiced/unvoiced determiner can be the neural network system 124 or a set of the envelope extractor 126 and the voiced grade calculator 118. When the controller 100 proceeds to step 412 of FIG. 4, the controller 100 determines in step 700 whether the voiced/unvoiced determination of the speech signal frame is performed using envelope information or the neural network system 124. The controller 100 determines whether the voiced/unvoiced determination of the speech signal frame is performed using envelope information or the neural network system 124, according to a characteristic of information requested by the speech signal processing system in a next stage or the amount of computation for the voiced/unvoiced determination of the speech signal frame.

When step 700 determines that the voiced/unvoiced determination of the speech signal frame is performed using envelope information, the controller 100 outputs the speech signal frame to the envelope extractor 126 and extracts secondary harmonic peak envelope information and non-harmonic peak envelope information through the envelope extractor 126 in step 702. The secondary harmonic peak envelope information and the non-harmonic peak envelope information can be extracted through the process shown in FIG. 5. The controller 100 outputs the secondary harmonic peak envelope information and the non-harmonic peak envelope information to the voiced grade calculator 118 and calculates a voiced grade of the speech signal frame through the voiced grade calculator 118 in step 704. The controller 100 determines in step 706 whether the input speech signal is a voiced sound, an unvoiced sound, or background noise, by comparing the calculated voiced grade to the pre-set voiced threshold or both the pre-set voiced threshold and the pre-set unvoiced threshold.

When step 700 determines that the voiced/unvoiced determination of the speech signal frame is performed using the neural network system 124, the controller 100 outputs the speech signal frame to the neural network system 124 and determines in step 708 whether a second neural network is used. The neural network system 124 can determine using a single neural network whether the speech signal frame corresponds to a voiced sound, an unvoiced sound, or background noise, based on weights pre-set to various kinds of characteristic information of the speech signal frame. In this case, the neural network system 124 returns the neural network recognition result to the controller 100 without performing second neural network recognition.

However, as described above, the neural network system 124 can have at least two neural networks. In this case, the neural network system 124 performs the second neural network recognition using a voiced sound/unvoiced sound/background noise determination result of the speech signal frame derived from a first neural network and secondary statistical values of various kinds of characteristic information extracted from the different speech signal frame and returns a voiced sound/unvoiced sound/background noise determination result obtained by performing the second neural network recognition to the controller 100.

When it can be determined using two neural networks whether the input speech signal is a voiced sound, an unvoiced sound, or background noise, and when step 700 determines that the voiced/unvoiced determination of the speech signal frame is performed using the neural network system 124, the controller 100 determines in step 708 whether the second neural network is used. That is, the controller 100 determines whether one or two neural networks are used for the voiced/unvoiced determination of the speech signal frame, according to the characteristic of information requested by the speech signal processing system in a next stage or the amount of computation for the voiced/unvoiced determination of the speech signal frame. For example, if the speech signal processing system requests correct distinguishment of whether the speech signal frame corresponds to an unvoiced sound or background noise, the controller 100 determines whether the speech signal frame corresponds to a voiced sound, an unvoiced sound, or background noise, using the second neural network which can distinguish an unvoiced sound from background noise more correctly than the use of the first neural network.

When step 708 determines that the second neural network is not used, the controller 100 performs only first neural network recognition through the neural network system 124 in step 710 and outputs a voiced sound/unvoiced sound/background noise determination result obtained by performing the first neural network recognition to the speech signal processing system in a next stage. When step 708 determines that the second neural network is used, the controller 100 performs the second neural network recognition in step 712 and outputs a voiced sound/unvoiced sound/background noise determination result obtained by performing the second neural network recognition to the speech signal processing system.

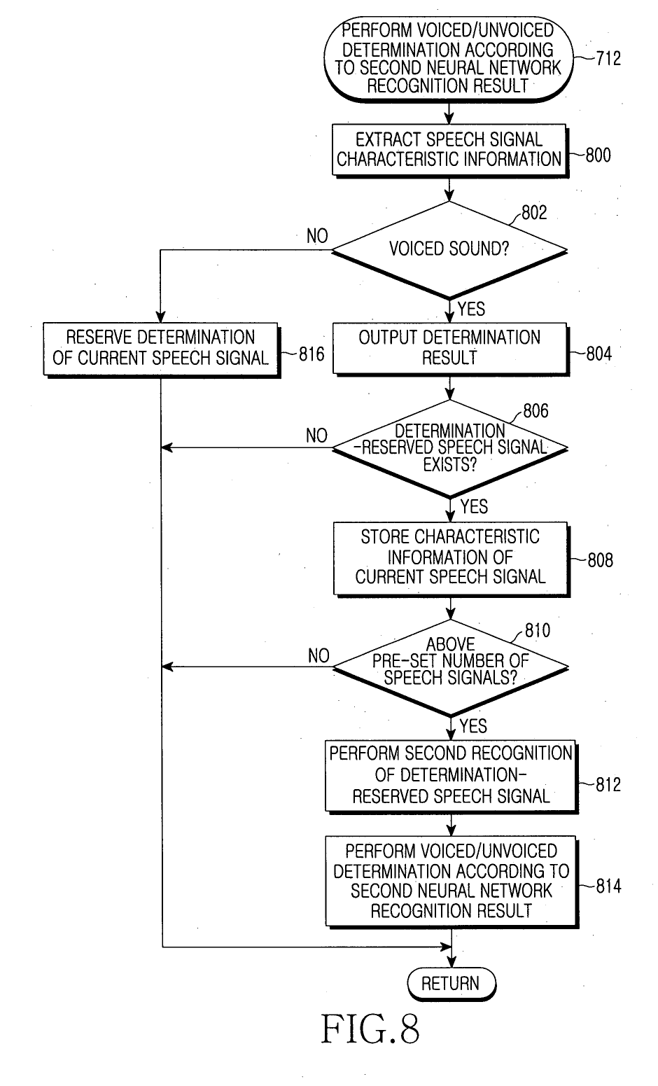

FIG. 8 shows where the second neural network is used, which is shown in step 712 of FIG. 7, according to the present invention. When step 708 of FIG. 7 determines that the second neural network is used, the neural network system 124 extracts the characteristic information of a speech signal by analyzing the speech signal frame in step 800. The speech signal characteristic information may be Root Mean Squared Energy of Signal (RMSE) and a Zero-crossing Count (ZC).

After extracting the characteristic information of the speech signal frame in step 800, the neural network system 124 performs first neural network recognition of the speech signal frame using the extracted characteristic information. The neural network system 124 determines in step 802 whether a result of the first neural network recognition indicates a voiced sound. When step 802 determines that the first neural network recognition result does not indicate a voiced sound, the neural network system 124 reserves in step 816 determination of whether the current speech signal frame corresponds to a voiced sound, an unvoiced sound, or background noise. Thereafter, the neural network system 124 receives a new speech signal frame.

When step 802 determines that the first neural network recognition result indicates a voiced sound, the neural network system 124 outputs the determination result of the speech signal frame to the controller 100 in step 804. The controller 100 outputs the determination result of the speech signal frame to the speech signal processing system.

The neural network system 124 determines in step 806 whether a determination-reserved speech signal frame exists. When step 806 determines that no determination-reserved speech signal frame exists, the neural network system 124 receives a new speech signal frame. When step 806 determines that a determination-reserved speech signal frame exists, the neural network system 124 stores characteristic information of a current speech signal frame in step 808. The neural network system 124 determines in step 810 whether characteristic information of a pre-set number of speech signal frames required to perform determination of the determination-reserved speech signal frame is stored.

When step 810 determines that the characteristic information of a pre-set number of speech signal frames is not stored, the neural network system 124 receives a new speech signal frame. When step 810 determines that the characteristic information of a pre-set number of speech signal frames is stored, the neural network system 124 provides the characteristic information of a pre-set number of speech signal frames to the second neural network and performs second neural network recognition of the determination-reserved speech signal frame in step 812. The neural network system 124 determines in step 814 according to the second neural network recognition result whether the speech signal frame is an unvoiced sound or background noise and outputs the determination result to the controller 100. The controller 100 outputs the determination result according to the second neural network recognition result to the speech signal processing system in a next stage as a determination result of the determination-reserved speech signal frame.

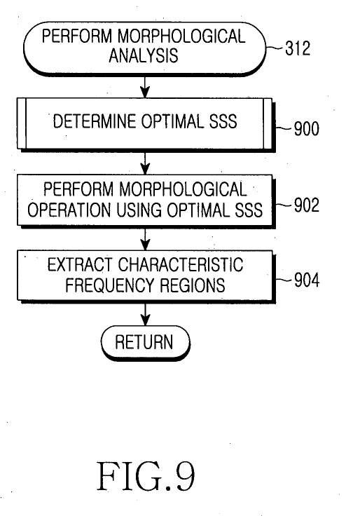

As described above with reference to FIG. 3, when step 304 determines that harmonic peaks are not used, the controller 100 performs a morphological analysis and extracts speech signal characteristic information according to the morphological analysis result in step 312. FIG. 9 shows a morphological analysis process of the speech signal pre-processing system shown in FIG. 1, wherein an input speech signal is analyzed using a morphological operation, according to the present invention.

Referring to FIG. 9, when step 304 of FIG. 3 determines that harmonic peaks are not used, the controller 100 determines an optimal SSS for optimizing the performance of a morphological operation in step 900. After determining the optimal SSS in step 900, the controller 100 performs a morphological operation of a speech signal waveform of the speech signal frame using the determined optimal SSS and performs pre-processing of the speech signal waveform in step 902. The morphological operation used is the morphological closing, which is accomplished by iteration of dilation and erosion. For an image signal, the morphological closing shows a ‘roll ball’ effect around an image, smoothing each corner while filtering the image from the outermost.

After performing the morphological closing and the pre-processing in step 902, the controller 100 extracts characteristic frequency regions according to a result of the morphological operation in step 904. In detail, when a waveform shown in waveform diagram (a) of FIG. 2 is obtained after performing the morphological closing of the speech signal frame, characteristic frequency regions having the waveform diagram (a) are extracted by pre-processing the waveform diagram (a). The extracted characteristic frequency regions indicate all sinusoidal frequency regions representing a speech signal, and a characteristic frequency can be obtained from the characteristic frequency regions.

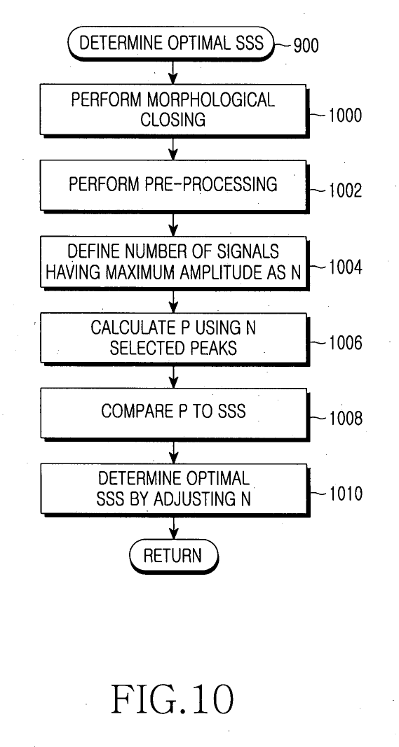

FIG. 10 shows a process of determining an optimal SSS for a morphological analysis in the process shown in FIG. 9, according to the present invention. If a speech signal frame is input, the controller 100 performs the morphological closing in step 1000 and outputs a waveform diagram (a) of FIG. 2. The controller 100 performs pre-processing of the waveform in step 1002. A test morphological operation result of a portion of the waveform is input to the SSS determiner 108 to determine an optimal SSS.

The controller 100 defines the number of signals having a maximum amplitude as N in step 1004 and calculates an energy ratio P of energy of N selected harmonic peaks to energy of the remaining harmonic peaks using the N selected harmonic peaks in step 1006. The controller 100 compares the energy ratio P to a current SSS in step 1008 and determines an optimal SSS by adjusting N according to the comparison result in step 1010. In other words, if the energy ratio P is greater than a predetermined value, N is decreased, and if the energy ratio P is less than the predetermined value, N is increased. That is, the optimal SSS can be obtained by adjusting N. The SSS is a value used to set the size of a sliding window for the morphological operation, and the performance of the morphological filter 106 depends on the size of the sliding window.

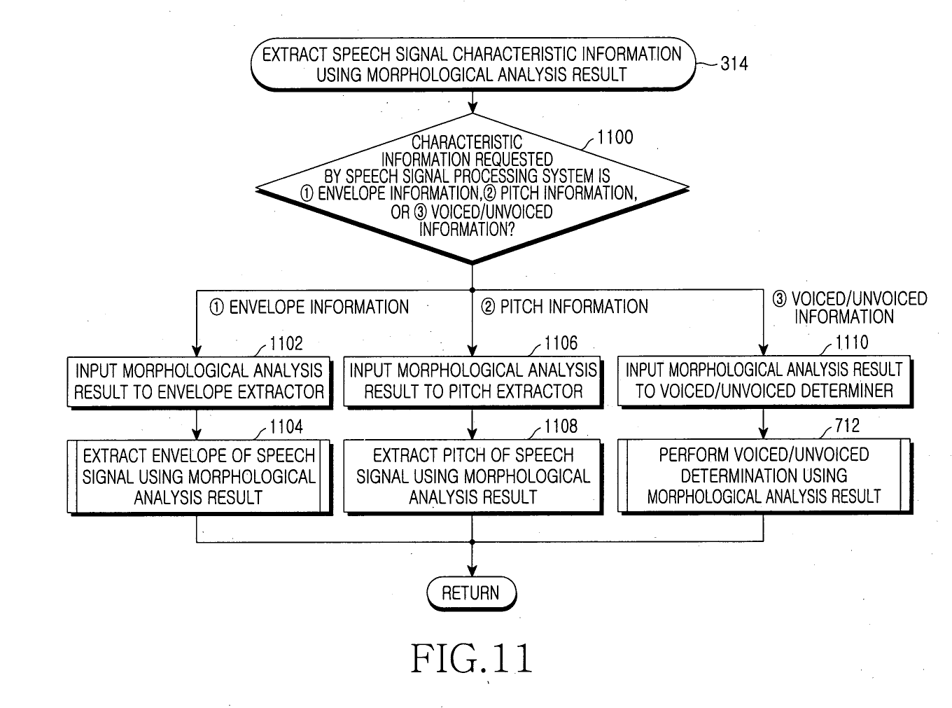

FIG. 11 shows a process of extracting the characteristic information of a speech signal using a signal waveform output according to a morphological analysis result in the speech signal pre-processing system shown in FIG. 1, according to the present invention.

When characteristic frequency regions having a signal waveform according to a morphological analysis result are input, the controller 100 determines in step 1100 whether speech signal characteristic information requested by the speech signal processing system according to the present invention is envelope information, pitch information, or voiced sound/unvoiced sound/background noise determination result information. According to the determination result of step 1100, the characteristic frequency regions are input to a corresponding speech signal characteristic extractor.

That is, when step 1100 determines that the speech signal characteristic information requested by the speech signal processing system is envelope information, the controller 100 outputs the characteristic frequency regions to the envelope extractor 126 in step 1102. The controller 100 extracts envelope information of the characteristic frequency regions by extracting harmonic peaks from the signal waveform of the characteristic frequency regions in step 1104. The envelope extractor 126 selects harmonic peaks by detecting the maximum peak as a first harmonic peak from the signal waveform of the characteristic frequency regions for a first pitch period and detecting the maximum harmonic peaks of subsequent search zones, and extracts the envelope information from the selected harmonic peaks using interpolation. After extracting the envelope information, the controller 100 outputs the extracted envelope information to the speech signal processing system in a next stage in step 316 of FIG. 3.

If the speech signal processing system in a next stage requests for not only the envelope information of the harmonic peaks, but also envelope information of other remaining peaks, i.e., non-harmonic envelope information, the non-harmonic envelope information can be extracted from the signal waveform of the characteristic frequency regions. The envelope extractor 126 may extract envelope information of secondary harmonic peaks of the characteristic frequency regions using the harmonic peaks of the characteristic frequency regions. The secondary harmonic peaks indicate harmonic peaks extracted from the envelope extracted from the signal waveform of the characteristic frequency regions.

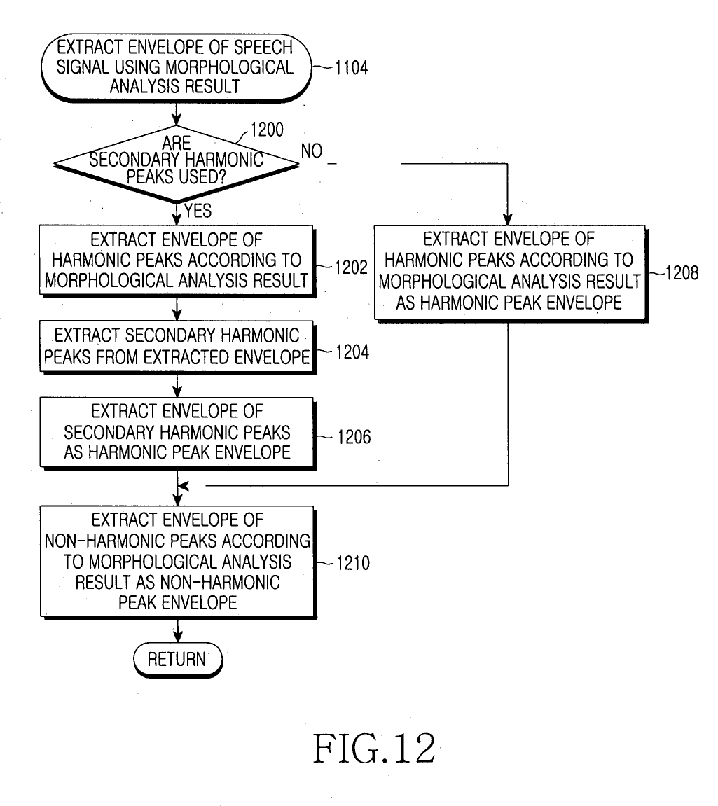

The envelope information of the secondary harmonic peaks may be used to increase an accuracy of a process of determining whether the characteristic frequency regions correspond to a voiced sound or an unvoiced sound. An operation of the envelope extractor 126 according to the present invention, which includes the process of extracting envelope information of secondary harmonic peaks extracted from a signal waveform of characteristic frequency regions, will be described later with reference to FIG. 12.

When step 1100 determines that the speech signal characteristic information requested by the speech signal processing system is pitch information, the controller 100 outputs the characteristic frequency regions to the pitch extractor 110 in step 1106. The controller 100 extracts pitch information of the speech signal using harmonic peaks of the characteristic frequency regions in step 1108. The controller 100 can use various methods to extract the pitch information from the characteristic frequency regions. For example, the controller 100 can use a method of extracting the pitch information by detecting an energy ratio of a harmonic area to a noise area from the characteristic frequency regions and determining peaks having the maximum energy ratio as the pitch information. After extracting the pitch information, the controller 100 outputs the extracted pitch information to the speech signal processing system in a next stage in step 316 of FIG. 3.

When step 1100 determines that the speech signal characteristic information requested by the speech signal processing system is a voiced sound/unvoiced sound/background noise determination result, the controller 100 outputs the characteristic frequency regions to a speech signal characteristic information extractor for determination of a voiced/unvoiced sound in step 1110. The controller 100 determines using the characteristic frequency regions in step 1112 whether the input speech signal is a voiced sound or an unvoiced sound. The voiced sound/unvoiced sound determination can be performed by using a recognition result of the neural network system 124 (the former) or using secondary harmonic peak envelope information and non-harmonic peak envelope information extracted by the envelope extractor 126 (the latter).

In the former case, the controller 100 outputs the characteristic frequency regions to the neural network system 124. According to a recognition result of the neural network system 124, the controller 100 determines whether the input speech signal is a voiced sound, an unvoiced sound, or background noise. In the latter case, the controller 100 outputs the characteristic frequency regions to the envelope extractor 126. The controller 100 extracts secondary harmonic peak envelope information and non-harmonic peak envelope information through the envelope extractor 126, and outputs the extracted secondary harmonic peak envelope information and non-harmonic peak envelope information to the voiced grade calculator 118. The voiced grade calculator 118 calculates an energy ratio of the secondary harmonic peak envelope information to the non-harmonic peak envelope information and compares the calculated envelope information energy ratio to the pre-set voiced threshold. If the envelope information energy ratio is greater than or equal to the pre-set voiced threshold, the voiced grade calculator 118 determines that the input speech signal is a voiced sound, and if the envelope information ratio is less than the pre-set voiced threshold, the voiced grade calculator 118 determines that the input speech signal is an unvoiced sound or background noise.

When the voiced threshold and the unvoiced threshold are set, the voiced grade calculator 118 may determine that the input speech signal is a voiced sound if the envelope information energy ratio is greater than the voiced threshold, an unvoiced sound if the envelope information energy ratio is less than the voiced threshold and greater than or equal to the unvoiced threshold, or background noise if the envelope information energy ratio is less than the unvoiced threshold. After extracting the determination result of step 1112, the controller 100 outputs the extracted determination result to the speech signal processing system in a next stage in step 316 of FIG. 3.

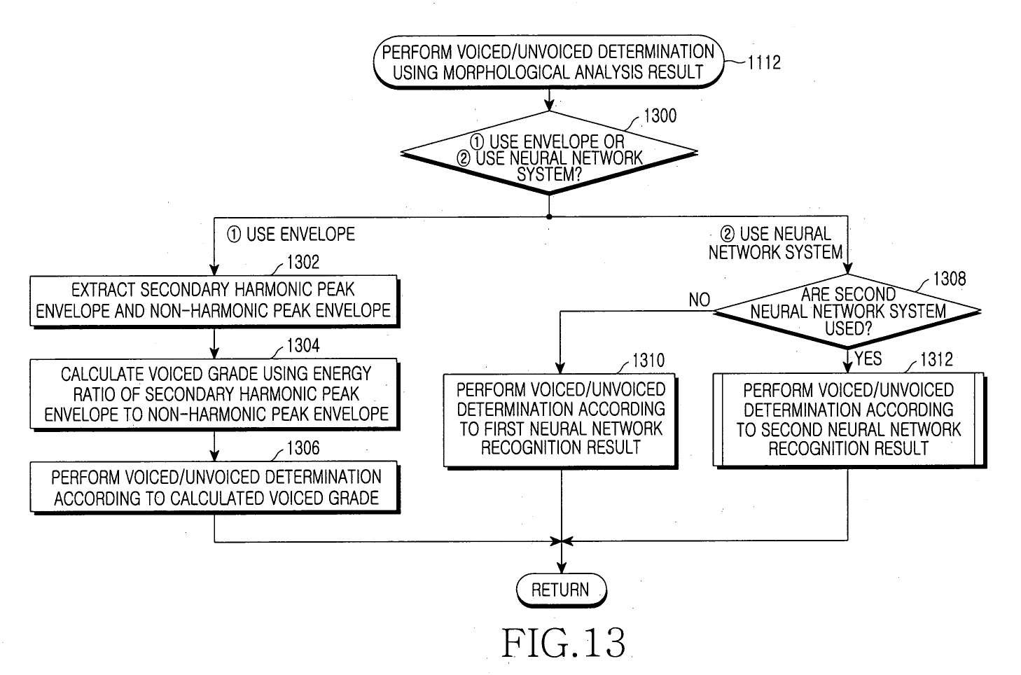

A process when the speech signal characteristic information requested by the speech signal processing system in a next stage is voiced/unvoiced sound determination result information will be described later with reference to FIG. 13.

FIG. 12 shows a process of extracting envelope information of a speech signal using a signal waveform output according to a morphological analysis result in the speech signal preprocessing system shown in FIG. 1, according to the present invention. When the voiced sound/unvoiced sound determination of the speech signal is performed in step 1112 of FIG. 11 using envelope information of the characteristic frequency regions, or when the characteristic frequency regions are input to the envelope extractor 126 in step 1102 of FIG. 11, the controller 100 determines in step 1200 whether secondary harmonic peaks are necessary. If the speech signal processing system in a next stage requests secondary harmonic peaks, or if secondary harmonic peaks are used in the voiced sound/unvoiced sound determination of the input speech signal of step 1112 of FIG. 11, the controller 100 determines in step 1200 that secondary harmonic peaks are necessary.

However, when step 1200 determines that secondary harmonic peaks are unnecessary, the controller -100 extracts envelope information by selecting harmonic peaks from the characteristic frequency regions and applying interpolation to the selected harmonic peaks in step 1208. The controller 100 extracts envelope information of the remaining peaks, which have not been selected as the harmonic peaks, as non-harmonic peak envelope information by applying interpolation to the remaining peaks in step 1210. If the non-harmonic peak envelope information is unnecessary, i.e., if the speech signal processing system in a next stage requests only the harmonic peak envelope information, step 1210 can be omitted.

When step 1200 determines that secondary harmonic peaks are necessary, the controller 100 extracts envelope information of harmonic peaks from the characteristic frequency regions in step 1202. The controller 100 extracts secondary harmonic peaks from the extracted envelope information in step 1204. The controller 100 extracts envelope information of the secondary harmonic peaks by applying interpolation to the selected secondary harmonic peaks in step 1206. The controller 100 extracts envelope information of the remaining peaks, which have not been selected as the harmonic peaks when the envelope information of the primary harmonic peaks were extracted, as non-harmonic peak envelope information by applying interpolation to the remaining peaks in step 1210. If the non-harmonic peak envelope information is unnecessary, i.e., if the voiced sound/unvoiced sound determination using the envelope information energy ratio is unnecessary or if the speech signal processing system in a next stage requests only the secondary harmonic peak envelope information, step 1210 can be omitted.

FIG. 13 shows a process of determining using a signal waveform output according to a morphological analysis result whether a speech signal is a voiced or unvoiced sound in the speech signal pre-processing system shown in FIG. 1, according to the present invention.

A voiced/unvoiced determiner for performing the voiced/unvoiced determination can be the neural network system 124 or a set of the envelope extractor 126 and the voiced grade calculator 118 based on the same reason as in FIG. 7 in which the voiced/unvoiced determination is performed using harmonic peaks. Thus, when the controller 100 proceeds to step 1012 of FIG. 10, the controller 100 determines in step 1300 whether the voiced/unvoiced determination is performed using envelope information extracted from the characteristic frequency regions or using the neural network system 124. The controller 100 determines whether the voiced/unvoiced determination of a speech signal corresponding to the characteristic frequency regions is performed using envelope information or the neural network system 124, according to a characteristic of information requested by the speech signal processing system in a next stage or the amount of computation for the voiced/unvoiced determination of the speech signal.

When step 1300 determines that the voiced/unvoiced determination of the speech signal corresponding to the characteristic frequency regions is performed using envelope information extracted from the characteristic frequency regions, the controller 100 outputs the characteristic frequency regions according to the morphological analysis result to the envelope extractor 126 and extracts secondary harmonic peak envelope information and non-harmonic peak envelope information through the envelope extractor 126 in step 1302. The secondary harmonic peak envelope information and the non-harmonic peak envelope information can be extracted through the process shown in FIG. 12.

The controller 100 outputs the secondary harmonic peak envelope information and the non-harmonic peak envelope information to the voiced grade calculator 11.8 and calculates a voiced grade of the speech signal corresponding to the characteristic frequency regions through the voiced grade calculator 118 in step 1304. The controller 100 determines in step 1306 whether the input speech signal is a voiced sound, an unvoiced sound, or background noise, by comparing the calculated voiced grade to the pre-set voiced threshold or both the pre-set voiced threshold and the pre-set unvoiced threshold.

When step 1300 determines that the voiced/unvoiced determination of the speech signal corresponding to the characteristic frequency regions is performed using the neural network system 124, the controller 100 outputs the characteristic frequency regions according to the morphological analysis result to the neural network system 124 and determines in step 1308 whether the second neural network is used. The neural network system 124 can determine using a single neural network or at least two neural networks whether the speech signal corresponding to the characteristic frequency regions corresponds to a voiced sound, an unvoiced sound, or background noise. If two neural networks are used, the neural network system 124 performs the second neural network recognition using a voiced sound/unvoiced sound/background noise determination result of the characteristic frequency regions derived from the first neural network and secondary statistical values of various kinds of characteristic information extracted from the characteristic frequency regions and returns a voiced sound/unvoiced sound/background noise determination result obtained by performing the second neural network recognition to the controller 100.

In this case, i.e., a case where it can be determined using two neural networks whether the input speech signal is a voiced sound, an unvoiced sound, or background noise, when step 1300 determines that the voiced/unvoiced determination of the speech signal corresponding to the characteristic frequency regions is performed using the neural network system 124, the controller 100 determines in step 1308 whether the second neural network is used. That is, the controller 100 determines whether one or two neural networks are used for the voiced/unvoiced determination of the speech signal corresponding to the characteristic frequency regions, according to the characteristic of information requested by the speech signal processing system in a next stage or the amount of computation for the voiced/unvoiced determination of the speech signal corresponding to the characteristic frequency regions. For example, if the speech signal processing system requests correct distinguishment of whether the input speech signal is an unvoiced sound or background noise, the controller 100 determines whether the speech signal corresponding to the characteristic frequency regions corresponds to a voiced sound, an unvoiced sound, or background noise, using the second neural network which can distinguish an unvoiced sound from background noise more correctly than the use of the first neural network.

When step 1308 determines that the second neural network is not used, the controller 100 performs only first neural network recognition through the neural network system 124 in step 1310 and outputs a voiced sound/unvoiced sound/background noise determination result obtained by performing the first neural network recognition to the speech signal processing system in a next stage. When step 1308 determines that the second neural network is used, the controller 100 performs the second neural network recognition in step 1312 and outputs a voiced sound/unvoiced sound/background noise determination result of the speech signal corresponding to the characteristic frequency regions to the speech signal processing system.

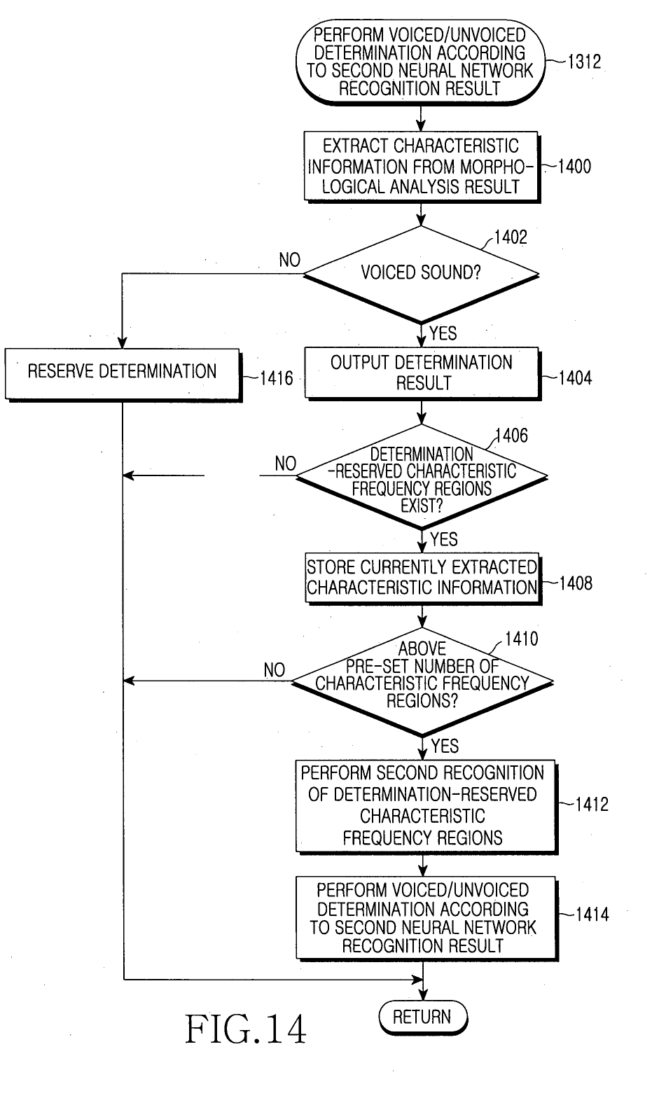

FIG. 14 shows a case where the second neural network is used in the process shown in FIG. 13, according to the present invention. Referring to FIG. 14, when step 1308 of FIG. 13 determines that the second neural network is used, the neural network system 124 extracts the characteristic information of a speech signal by analyzing the characteristic frequency regions according to the morphological analysis result in step 1400. The speech signal characteristic information may be Root Mean Squared Energy of Signal (RMSE).

After extracting the characteristic information of the characteristic frequency regions in step 1400, the neural network system 124 performs first neural network recognition of the characteristic frequency regions using the extracted characteristic information. The neural network system 124 determines in step 1402 whether a result of the first neural network recognition indicates a voiced sound. When step 1402 determines that the first neural network recognition result does not indicate a voiced sound, the neural network system 124 reserves in step 1416 determination of whether a speech signal corresponding to the current characteristic frequency regions corresponds to a voiced sound, am unvoiced sound, or background noise. Thereafter, the neural network system 124 receives new characteristic frequency regions.

When step 1402 determines that the first neural network recognition result indicates a voiced sound, the neural network system 124 outputs the determination result of the first neural network recognition to the controller 100 in step 1404. The controller 100 outputs the determination result to the speech signal processing system in a next stage.

The neural network system 124 determines in step 1406 whether determination-reserved characteristic frequency regions exist. When step 1406 determines that the determination-reserved characteristic frequency regions do not exist, the neural network system 124 receives new characteristic frequency regions. When step 1406 determines that determination-reserved characteristic frequency regions exist, the neural network system 124 stores characteristic information extracted from the current characteristic frequency regions in step 1408. The neural network system 124 determines in step 1410 whether characteristic information of a pre-set number of characteristic frequency regions required to perform determination of a speech signal corresponding to the determination-reserved characteristic frequency regions is stored.

When step 1410 determines that the characteristic information of a pre-set number of characteristic frequency regions is not stored, the neural network system 124 receives new characteristic frequency regions. When step 1410 determines that the characteristic information of a pre-set number of speech signal frames is stored, the neural network system 124 provides the characteristic information of a pre-set number of characteristic frequency regions to the second neural network and performs second neural network recognition of the speech signal corresponding to the determination-reserved characteristic frequency regions in step 1412. The neural network system 124 determines in step 1414 according to the second neural network recognition result whether the speech signal corresponding to the determination-reserved characteristic frequency regions corresponds to an unvoiced sound or background noise and outputs the determination result to the controller 100. The controller 100 outputs the determination result according to the second neural network recognition result to the speech signal processing system in a next stage as a determination result of the speech signal corresponding to the determination-reserved characteristic frequency regions.

As described above, according to the present invention, by synthetically extracting characteristic information of a speech signal from an input speech signal, characteristics of a speech signal, which are requested by a speech signal processing system, can be selectively provided according to characteristics of various speech signal processing systems which use harmonic peaks or not.

While the invention has been shown and described with reference to certain preferred embodiments thereof, it will be understood by those skilled in the art that various changes in form and details may be made therein without departing from the spirit and scope of the invention. In particular, although it is assumed in the embodiments of the present invention that a speech signal processing system in a stage next to a speech signal pre-processing system requests envelope information, pitch information, and voiced sound/unvoiced sound/background noise determination result information, the invention is not limited to this. In addition, although various methods of extracting the envelope information, the pitch information, and the voiced sound/unvoiced sound/background noise determination result information are suggested, other methods performing the same functions as the suggested methods can be applied to the invention. Thus it will be understood by those skilled in the art that various changes in form and details may be made therein without departing from the spirit and scope of the invention as defined by the appended claims.

What is claimed is:

1. A speech signal pre-processing system comprising:
a speech signal recognition unit for recognizing speech from an input signal and outputting the input signal as a speech signal;
a speech signal converter for generating a speech signal frame by receiving the speech signal and converting the received speech signal of a time domain to a speech signal of a frequency domain;
a morphological analyzer for receiving the speech signal frame and generating characteristic frequency regions having a morphological analysis-based signal waveform through a morphological operation;
a speech signal characteristic information extractor for receiving the speech signal frame or the morphological analysis-based characteristic frequency regions and extracting speech signal characteristic information requested by a speech signal processing system in a next stage; and
a controller for determining according to a pre-set determination condition whether the characteristic information of the speech signal is extracted using harmonic peaks of the speech signal frame, and extracting the speech signal characteristic information requested by the speech signal processing system by outputting the speech signal frame to the speech signal characteristic information extractor when harmonic peaks are used or outputting the morphological analysis-based characteristic frequency regions of the speech signal frame when harmonic peaks are not used.

2. The speech signal pre-processing system of claim 1, wherein the pre-set determination condition is a characteristic of the input signal or the speech signal processing system.

3. The speech signal pre-processing system of claim 1, further comprising a harmonic peak extractor for searching for and extracting harmonic peaks from the speech signal frame.

4. The speech signal pre-processing system of claim 1, further comprising a noise canceller for canceling noise from the speech signal frame.

5. The speech signal pre-processing system of claim 1, wherein the morphological analyzer comprises:
a morphological filter for performing a morphological operation of the speech signal frame based on a pre-set window size and extracting a characteristic frequency from a result of the morphological operation by performing morphological closing and pre-processing with respect to the converted speech signal waveform; and
a structuring set size (SSS) determiner for determining an optimal SSS of the morphological filter, which performs the morphological closing with respect to the speech signal frame.

6. The speech signal pre-processing system of claim 1, wherein the speech signal characteristic information extractor comprises:
an envelope extractor for extracting at least one of envelope information of harmonic peaks and envelope information of non-harmonic peaks from the speech signal frame or characteristic frequency regions according to a morphological analysis result;
a pitch extractor for extracting pitch information using the speech signal frame or the characteristic frequency regions according to the morphological analysis result; and
a neural network system for detecting characteristic information from the speech signal frame or the characteristic frequency regions according to the morphological analysis result, granting a pre-set weight to each piece of the detected characteristic information, and determining according to a neural network recognition result whether the speech signal frame corresponds to a voiced sound, an unvoiced sound, or background noise.

7. The speech signal preprocessing system of claim 6, wherein the neural network system has two neural networks.

8. The speech signal pre-processing system of claim 7, wherein if a determination result of the speech signal frame or a speech signal corresponding to the characteristic frequency regions according to first neural network recognition, does not indicate a voiced sound, the neural network system reserves the determination of the speech signal frame or the characteristic frequency regions, performs second neural network recognition using a voiced sound/unvoiced sound/background noise determination result of a first neural network with respect to at least one different speech signal frame or characteristic frequency regions, and secondary statistical values of various kinds of characteristic information extracted from the different speech signal frames or characteristic frequency regions, and determines according to a result of the second neural network recognition whether the input speech signal is a voiced sound, an unvoiced sound, or background noise.

9. The speech signal pre-processing system of claim 6, wherein the pitch extractor extracts the pitch information by detecting an energy ratio of a harmonic area to a noise area from the characteristic frequency regions and determining peaks having a maximum energy ratio as the pitch information.

10. The speech signal pre-processing system of claim 5, wherein the envelope extractor extracts the harmonic peak envelope information by detecting a maximum peak as a first harmonic peak from the speech signal frame or the characteristic frequency regions for a first pitch period, selecting harmonic peaks through a process of detecting maximum harmonic peaks of subsequent search zones, and applying interpolation to the selected harmonic peaks.

11. The speech signal pre-processing system of claim 10, wherein the envelope extractor extracts the non-harmonic peak envelope information by selecting peaks, which have not been selected as the harmonic peaks, and applying interpolation to the selected peaks.

12. The speech signal pre-processing system of claim 11, wherein the controller determines, using the harmonic peak envelope information and the non-harmonic peak envelope information, whether the speech signal frame corresponds to a voiced sound or an unvoiced sound.

13. The speech signal pre-processing system of claim 12, further comprising a voiced grade calculator for calculating a voiced grade by calculating an energy ratio of the harmonic peak envelope information to the non-harmonic peak envelope information.

14. The speech signal pre-processing system of claim 13, wherein the controller determines whether the speech signal frame or a speech signal corresponding to the characteristic frequency regions is a voiced sound, an unvoiced sound, or background noise, by comparing the calculated voiced grade to a pre-set voiced threshold or both the pre-set voiced threshold and a pre-set unvoiced threshold.

15. The speech signal pre-processing system of claim 13, wherein the envelope extractor extracts secondary harmonic peak envelope information by selecting secondary harmonic peaks from the selected harmonic peaks using the harmonic peak envelope information and applying interpolation to the selected secondary harmonic peaks.

16. The speech signal pre-processing system of claim 15, wherein the voiced grade calculator calculates a voiced grade by calculating an energy ratio of the secondary harmonic peak envelope information to the non-harmonic peak envelope information.

17. The speech signal pre-processing system of claim 13, wherein the controller determines whether the speech signal frame or a speech signal corresponding to the characteristic frequency regions is a voiced sound, an unvoiced sound, or background noise, by comparing the calculated voiced grade to a pre-set voiced threshold or both the pre-set voiced threshold and a pre-set unvoiced threshold.

18. A method of extracting characteristic information of a speech signal, the method comprising the steps of:
generating a speech signal frame by recognizing speech from an input signal, extracting the speech, converting the received input signal of a time domain to a speech signal of a frequency domain, and outputting the speech signal;
determining, according to a pre-set determination condition, whether characteristic information of the speech signal is extracted using harmonic peaks of the speech signal frame;
performing a morphological analysis of the speech signal frame according to a harmonic peaks usage determination result and extracting characteristic frequency regions according to a morphological analysis result;
extracting speech signal characteristic information requested by a speech signal processing system in a next stage using the characteristic frequency regions or the speech signal frame according to a harmonic peaks usage determination result; and
outputting the extracted speech signal characteristic information to the speech signal processing system.

19. The method of claim 18, wherein the step of generating a speech signal frame comprises:
recognizing a speech signal from the input signal;
generating a speech signal frame by converting the received speech signal of a time domain to a speech signal of a frequency domain; and
canceling noise from the speech signal frame.

20. The method of claim 19, wherein the step of canceling noise comprises setting a larger amplitude ratio of a signal having an amplitude less than a pre-set threshold to a signal having an amplitude greater than or equal to the pre-set threshold by setting weights according to an amplitude of the speech signal frame performing a square operation of each amplitude based on the set weights, and granting a (+) or (−) sign to a result of the square operation based on the pre-set threshold.

21. The method of claim 18, wherein the step of determining comprises determining according to a characteristic of the speech signal frame or the speech signal processing system in a next stage whether characteristic information of the speech signal is extracted using harmonic peaks of the speech signal frame.

22. The method of claim 18, wherein the step of performing comprises:
determining an optimal structuring set size (SSS) of the morphological filter, which performs morphological closing with respect to the speech signal frame;
performing a morphological operation with respect to the speech signal frame based on a window size according to the determined SSS; and
extracting a characteristic frequency by performing the morphological closing of the speech signal frame using the morphological operation result and performing pre-processing in which only harmonic signals are obtained by removing staircase signals from the converted speech signal.

23. The method of claim 22, wherein the step of determining an optimal SSS is represented by the equation below
window size=(structuring set size (SSS)×2+1).

24. The method of claim 18, wherein the step of extracting the speech signal characteristic information comprises extracting envelope information from the speech signal frame or the characteristic frequency regions.

25. The method of claim 24, wherein the step of extracting envelope information comprises:
receiving the speech signal frame or the characteristic frequency regions;
detecting a maximum peak as a first harmonic peak from the speech signal frame or the characteristic frequency regions for a first pitch period;
selecting harmonic peaks of subsequent search zones; and
extracting harmonic peak envelope information by applying interpolation to the selected harmonic peaks.

26. The method of claim 25, further comprising extracting non-harmonic peak envelope information by selecting peaks, which have not been selected as the harmonic peaks, and applying interpolation to the selected peaks which have not been selected as the harmonic peaks.

27. The method of claim 18, wherein the step of extracting the speech signal characteristic information comprises extracting pitch information from the speech signal frame or the characteristic frequency regions.

28. The method of claim 27, wherein the step of extracting pitch information comprises:
detecting an energy ratio of a harmonic area to a noise area from the speech signal frame or the characteristic frequency regions; and
extracting the pitch information by determining peaks having a maximum energy ratio as the pitch information.

29. The method of claim 18, wherein the step of extracting the speech signal characteristic information comprises determining whether the speech signal frame or a speech signal corresponding to the characteristic frequency regions corresponds to a voiced sound, an unvoiced sound, or background noise.

30. The method of claim 29, wherein the step of determining comprises:
determining according to a pre-set condition whether envelope information extracted from the speech signal frame or the characteristic frequency regions is used or a neural network recognition method using characteristic information extracted from the speech signal frame or the characteristic frequency regions is used; and
determining whether the speech signal frame or a speech signal corresponding to the characteristic frequency regions corresponds to a voiced sound, an unvoiced sound, or background noise, by selecting the method using the envelope information or the neural network recognition method according to the determination result according to the pre-set condition.

31. The method of claim 30, wherein the method using the envelope information comprises:
receiving the speech signal frame or the characteristic frequency regions;
selecting harmonic peaks from the speech signal frame or the characteristic frequency regions;
extracting harmonic peak envelope information by applying interpolation to the selected harmonic peaks;
extracting non-harmonic peak envelope information by selecting peaks, which have not been selected as the harmonic peaks, and applying interpolation to the selected peaks which have not been selected as the harmonic peaks;
calculating an energy ratio of the harmonic peak envelope information to the non-harmonic peak envelope information as a voiced grade; and
determining according to the voiced grade whether the speech signal frame or a speech signal corresponding to the characteristic frequency regions corresponds to a voiced sound or an unvoiced sound.

32. The method of claim 31, wherein the step of extracting harmonic peak envelope information comprises:
selecting secondary harmonic peaks from the selected harmonic peaks using the extracted harmonic peak envelope information; and
extracting envelope information of the secondary harmonic peaks by applying interpolation to the selected secondary harmonic peaks and extracting the information of the secondary harmonic peaks as secondary harmonic peak envelope information.

33. The method of claim 32, wherein the step of calculating a voiced grade comprises calculating an energy ratio of the secondary harmonic peak envelope information to the non-harmonic peak envelope information as the voiced grade.

34. The method of claim 31, wherein the step of determining comprises comparing the calculated voiced grade to a pre-set voiced threshold and determining according to the comparison result whether the speech signal frame or a speech signal corresponding to the characteristic frequency regions is a voiced sound or an unvoiced sound.

35. The method of claim 31, wherein the step of determining comprises comparing the calculated voiced grade to both a pre-set voiced threshold and a pre-set unvoiced threshold and determining according to the comparison result whether the speech signal frame or a speech signal corresponding to the characteristic frequency regions is a voiced sound, an unvoiced sound, or background noise.

36. The method of claim 30, wherein the neural network recognition method comprises:
extracting characteristic information from the speech signal frame or the characteristic frequency regions; and
determining whether the speech signal frame or a speech signal corresponding to the characteristic frequency regions is a voiced sound, an unvoiced sound, or background noise, by granting pre-set weights to the extracted characteristic information and performing a neural network operation based on the granted weights.

37. The method of claim 30, wherein the neural network recognition method comprises:
extracting characteristic information from the speech signal frame or the characteristic frequency regions;
determining whether the speech signal frame or a speech signal corresponding to the characteristic frequency regions is a voiced sound, by inputting the extracted characteristic information and weights granted to the extracted characteristic information to a first neural network;
outputting the first neural network recognition result as a determination result of the speech signal frame or the speech signal corresponding to the characteristic frequency regions if it is determined as a first neural network recognition result that the speech signal frame or the speech signal, and reserving determination of the speech signal frame or the speech signal corresponding to the characteristic frequency regions if it is determined as the first neural network recognition result that the speech signal frame or the speech signal corresponding to the characteristic frequency regions is not a voiced sound;
checking whether a determination-reserved speech signal exists if it is determined as the first neural network recognition result that the speech signal frame or the speech signal corresponding to the characteristic frequency regions is a voiced sound;
storing characteristic information extracted from more than a pre-set number of speech signal frames or characteristic frequency regions if it is determined as the checking result that a determination-reserved speech signal exists;
determining whether the speech signal frame or the speech signal corresponding to the characteristic frequency regions is a unvoiced sound or background noise, by inputting the first neural network recognition result of the determination-reserved speech signal, secondary statistical values of the information extracted from more than a pre-set number of speech signal frames or characteristic frequency regions, and weights set to the first neural network recognition result and the secondary statistical values to a second neural network; and
determining according to a second neural network recognition result whether the determination-reserved speech signal is a voiced sound, an unvoiced sound, or background noise.
